(19) United States
(12) Patent Application Publication
(10) Pub. No.: US 2020/0150491 A1
(43) Pub. Date: May 14, 2020

(54) BACKLIGHT UNIT, DISPLAY APPARATUS HAVING THE BACKLIGHT UNIT AND CONTROL METHOD FOR THE DISPLAY APPARATUS

(71) Applicant: SAMSUNG ELECTRONICS CO., LTD., Suwon-si (KR)

(72) Inventors: Nae Won JANG, Suwon-si (KR); Jeong Shan NA, Suwon-si (KR)

(73) Assignee: SAMSUNG ELECTRONICS CO., LTD., Suwon-si (KR)

(21) Appl. No.: 16/674,231

(22) Filed: Nov. 5, 2019

(30) Foreign Application Priority Data
Nov. 9, 2018 (KR) 10-2018-0137311

(51) Int. Cl. G02F 1/1335; H05B 37/02; G09G 3/34

(52) U.S. Cl. CPC G02F 1/133617; H05B 37/0209; G02F 1/133605; G09G 3/3406; G02F 2001/133614; G09G 2320/0666; G02F 1/133611; G02F 2001/133607; G02F 2001/133613; G02F 2001/133612; G09G 2320/062; G02F 1/133606

(57) ABSTRACT

Provided are a backlight unit, a display apparatus including the backlight unit and a control method for the display apparatus. The display apparatus includes: a first light source configured to emit first light having a first wavelength; a second light source configured to emit second light having a second wavelength shorter than the first wavelength of the first light; an image signal receiver configured to receive an image signal from an external device; a switching portion configured to operate at least one of the first light source or the second light source; and a controller configured, based on a brightness value of the received image signal, to control the switching portion to selectively allow at least one of the first light source to emit the first light or the second light source to emit the second light.

### CROSS-REFERENCE TO RELATED APPLICATION(S)

This application is based on and claims priority under 35 U.S.C. § 119 to Korean Patent Application No. 10-2018-0137311, filed on Nov. 9, 2018, in the Korean Intellectual Property Office, the disclosure of which is incorporated by reference herein in its entirety.

### BACKGROUND

### 1. Field

The disclosure relates to a backlight unit, a display apparatus including the backlight unit and a control method for the display apparatus, and more particularly, to a technique for increasing color conversion efficiency of a quantum dot filter layer and increasing color reproducibility of a display apparatus.

### 2. Description of the Related Art

Generally, a display apparatus is a kind of an output apparatus that visually displays acquired or stored image information to a user, and is used in various fields such as in a home or a workplace.

The display apparatus may include a monitor apparatus connected to a personal computer or a server computer, a portable computing device, a navigation terminal device, a general television apparatus, an Internet Protocol television (IPTV) device, a portable terminal device (such as a smart phone, a tablet PC, a personal digital assistant (PDA) or a cellular phone), various display apparatuses used to reproduce images such as advertisements or movies in an industrial field, or various kinds of audio/video systems.

The display panel is classified into a self-emissive display panel that emits light by itself, and a non-self-emissive display panel that requires a separate light source. The self-emissive display panel may include a cathode ray tube (CRT) panel, an electro luminescence (EL) panel, an organic light emitting diode (OLED) panel, a vacuum fluorescence display (VFD) panel, a field emission display (FED) panel, and a plasma display panel (PDP). The non-self-emissive display panel may include a liquid crystal display (LCD) panel.

A display apparatus including the liquid crystal display panel further includes a backlight unit emitting light toward the rear of the liquid crystal display panel. The light emitted from the backlight unit displays color while passing through a color filter provided in the liquid crystal display panel.

In addition, the backlight unit uses a method of filtering by converting color of light emitted from the light source by using quantum dots. In a related art, because a light source of a backlight unit employs a single source and color reproducibility is determined according to its own characteristics of the quantum dot, the display apparatus has a limit in implementing various deep colors.

### SUMMARY

Provided are a backlight unit capable of increasing color conversion efficiency by quantum dots and capable of increasing color reproducibility of a display apparatus through designing a light source of the backlight unit, a display apparatus having the backlight unit and a control method for the display apparatus.

Additional aspects will be set forth in part in the description which follows and, in part, will be apparent from the description, or may be learned by practice of the presented embodiments.

In accordance with an aspect of the disclosure, a display apparatus includes: a first light source configured to emit first light having a first wavelength; a second light source configured to emit second light having a second wavelength shorter than the first wavelength of the first light; an image signal receiver configured to receive an image signal from an external device; a switching portion configured to operate at least one of the first light source or the second light source; and a controller configured, based on a brightness value of the received image signal, to control the switching portion to selectively allow at least one of the first light source to emit the first light or the second light source to emit the second light.

The switching portion may include: a first switch configured to operate the first light source to emit the first light according to a control of the controller; and a second switch configured to operate the second light source to emit the second light according to a control of the controller.

The first light emitted from the first light source may include blue light (BL), and the second light emitted from the second light source may include ultraviolet light (UV) of a predetermined wavelength.

Based on the brightness value of the received image signal being less than a predetermined value, the controller may be configured to control the first switch to operate the first light source to emit the first light.

Based on the brightness value of the received image signal being equal to or greater than a predetermined value, the controller may be configured to control the second switch to operate the second light source to emit the second light.

Based on the received image signal corresponding to a signal having a predetermined color, the controller may be configured to control the first switch to operate the first light source to emit the first light, and the second switch to operate the second light source to emit the second light.

The display apparatus may further include: a support configured to fix the first light source and the second light source, wherein the first light source and the second light source may be spaced apart from each other on the support by a predetermined distance.

The display apparatus may further include: a reflective sheet configured to reflect light, wherein the reflective sheet may include through holes formed at positions corresponding to the first light source and the second light source, and wherein the first light source and the second light source may pass through the through holes and protrude from the through holes toward the front of the reflective sheet.

The display apparatus may further include: a quantum dot color filter layer configured to convert a color of light emitted from at least one of the first light source or the second light source.

The quantum dot color filter layer may include: a red light converter configured to convert incident light, which is emitted from at least one of the first light source or the second light source and then incident thereon, into red light; a green light converter configured to convert incident light, which is emitted from at least one of the first light source or the second light source and then incident thereon, into green light; and a light transmitter configured to transmit incident light, which is emitted from at least one of the first light source or the second light source, and then incident thereon, without converting a color thereof.

In accordance with another aspect of the disclosure, a backlight unit includes: a first light source configured to emit first light having a first wavelength; a second light source configured to emit second light having a second wavelength shorter than the first wavelength of the first light; a support configured to fix the first light source and the second light source; and a reflective sheet configured to reflect at least one of the first light or the second light, wherein the reflective sheet includes through holes formed at positions corresponding to the first light source and the second light source, and wherein the first light source and the second light source pass through the through holes and protrude from the through holes toward the front of the reflective sheet.

The first light emitted from the first light source may include blue light (BL), and the second light emitted from the second light source may include ultraviolet light (UV) of a predetermined wavelength.

The backlight unit may further include: a quantum dot color filter layer configured to convert a color of light emitted from at least one of the first light source or the second light source.

The quantum dot color filter layer may include: a red light converter configured to convert incident light, which is emitted from at least one of the first light source or the second light source and then incident thereon, into red light; a green light converter configured to convert incident light, which is emitted from at least one of the first light source or the second light source and then incident thereon, into green light; and a light transmitter configured to transmit incident light, which is emitted from at least one of the first light source or the second light source and then incident thereon, without converting a color thereof.

The first light source and the second light source may be spaced apart from each other on the support by a predetermined distance.

In accordance with another aspect of the disclosure, a control method for a display apparatus including a first light source configured to emit first light having a first wavelength, a second light source configured to emit second light having a second wavelength shorter than the first wavelength, and a switching portion configured to operate at least one of the first light source or the second light source, includes: receiving an image signal input from an external device; comparing a brightness value of the received image signal with a predetermined value; and controlling the switching portion to selectively allow, based on a result of the comparing, at least one of the first light source to emit the first light or the second light source to emit the second light.

The controlling the switching portion may include controlling the first switch to operate the first light source to emit the first light based on the brightness value of the received image signal being less than a predetermined value.

The controlling the switching portion may include controlling the second switch to operate the second light source to emit the second light based on the brightness value of the received image signal being equal to or greater than the predetermined value.

The controlling the switching portion may include controlling the first switch to operate the first light source to emit the first light and the second switch to operate the second light source to emit the second light, based on the received image signal corresponding to a signal having a predetermined color.

In accordance with another aspect of the disclosure, a non-transitory computer-readable recording medium has recorded thereon one or more instructions executable by a processor to perform the control method.

In accordance with another aspect of the disclosure, a display control apparatus includes: a memory storing one or more instructions; and at least one processor configured to execute the instructions to: obtain a brightness value of an image signal; based on the obtained brightness value of the image signal, control to selectively operate at least one of a first light source to emit first light having a first wavelength and a second light source to emit second light having a second wavelength shorter than the first wavelength.

The first light may be blue light (BL), and the second light may be ultraviolet light (UV) of a predetermined wavelength.

Based on the brightness value of the image signal being less than a predetermined value, the at least one processor may be configured to control to operate the first light source to emit the first light.

Based on the brightness value of the image signal being equal to or greater than a predetermined value, the at least one processor may be configured to control to operate the second light source to emit the second light.

Based on the image signal corresponding to a signal having a predetermined color, the at least one processor may be configured to control to operate the first light source to emit the first light, and the second light source to emit the second light.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating an exterior of a display apparatus according to an embodiment;

FIG. 2 is an exploded view illustrating an display apparatus according to an embodiment;

FIG. 3 is a side cross-sectional view illustrating a single pixel contained in an image generator of a display apparatus according to an embodiment;

FIG. 4 is an exploded view illustrating a backlight unit according to an embodiment;

FIG. 5 is a view illustrating an internal configuration of a quantum dot color filter layer according to an embodiment;

FIG. 6 is a side cross-sectional view illustrating a backlight unit according to an embodiment;

FIG. 7 is an exploded view illustrating a backlight unit according to another embodiment;

FIG. 8 is a side cross-sectional view illustrating a backlight unit according to another embodiment;

FIG. 9 is a control block diagram of a display apparatus according to an embodiment;

FIG. 10 is a view illustrating a state in which a first light source emits first light according to an embodiment;

FIG. 11 is a view illustrating a state in which a second light source emits second light according to an embodiment;

FIG. 12 is a view illustrating a state in which a first light source emits first light and a second light source emits second light, simultaneously, according to an embodiment;

FIG. 13 is a view illustrating a spectrum in which a quantum dot color filter layer absorbs and emits first light and second light, according to an embodiment;

FIG. 14 is a view illustrating a change in a color gamut of a display apparatus according to an embodiment; and

FIG. 15 is a flowchart illustrating a control method of a display apparatus according to an embodiment; and

FIG. 16 is a flowchart illustrating a control method of a display apparatus according to an embodiment.

### DETAILED DESCRIPTION

In the following description, like reference numerals refer to like elements throughout the specification. Well-known functions or constructions are not described in detail since they would obscure the one or more exemplar embodiments with unnecessary detail. Terms such as “unit,” “module,” “member,” and “block” may be embodied as hardware or software. According to embodiments, a plurality of “units,” “modules,” “members,” and “blocks” may be implemented as a single component, and a single “unit,” “module,” “member,” and “block” may include a plurality of components.

It will be understood that when an element is referred to as being “connected” to or with another element, it can be directly or indirectly connected to the other element, wherein the indirect connection may include “connection via a wireless communication network.”

Also, when a part “includes” or “comprises” an element, unless there is a particular description contrary thereto, the part may further include other elements, not excluding the other elements.

It will be understood that, although the terms first, second, third, etc., may be used herein to describe various elements, the elements are not be limited by these terms. These terms are only used to distinguish one element from another element.

As used herein, the singular forms “a,” “an” and “the” are intended to include the plural forms as well, unless the context clearly indicates otherwise.

An identification code or number is used for the convenience of the description but is not intended to illustrate the order of each step. That is, each step may be implemented in the order different from the illustrated order unless the context clearly indicates otherwise.

Hereinafter, it is understood that expressions such as “at least one of,” when preceding a list of elements, modify the entire list of elements and do not modify the individual elements of the list. For example, the expression “at least one of [A], [B], and [C]” means only A, only B, only C, A and B, B and C, A and C, or A, B, and C.

It is understood that white light represents light in which red light, green light and blue light are mixed, or light in which blue light and yellow light are mixed. In addition, natural light represents light in which light of all wavelengths corresponding to the visible light region is mixed.

Reference will now be made in detail to embodiments, examples of which are illustrated in the accompanying drawings.

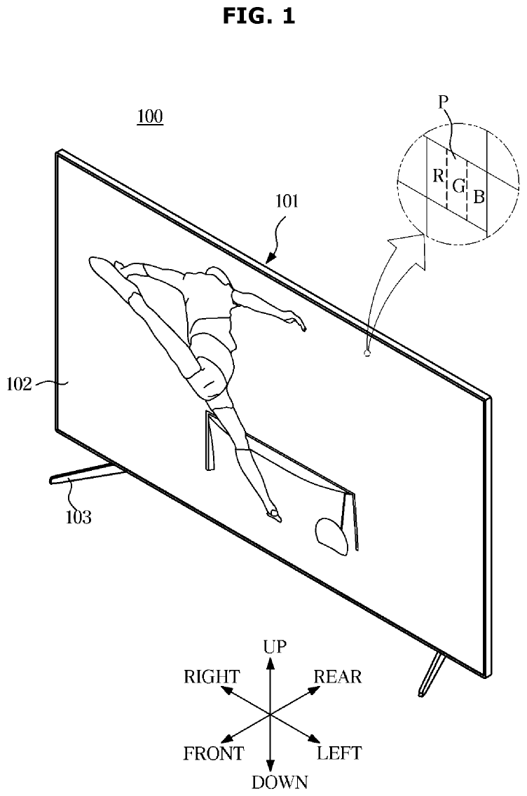

FIG. 1 is a view illustrating an exterior of a display apparatus 100 according to an embodiment.

A display apparatus 100 is a device that processes an image signal received from the outside and visually displays the processed image. Hereinafter, a case in which the display apparatus 100 is a television is exemplified, but it is understood that embodiments are not limited thereto. For example, the display apparatus 100 may be implemented in various forms such as a monitor, a portable multimedia device, a portable communication device, and a portable computing device, and the display apparatus 100 is not limited in its shape as long as visually displaying an image.

As illustrated in FIG. 1, the display apparatus 100 may include a body 101, a screen 102 displaying an image, and a support 103 provided under the body 101 to support the body 101.

The body 101 may form an outer shape of the display apparatus 100, and the body 101 may include a component configured to allow the display apparatus 100 to display an image or a component configured to perform a variety of functions. Although the body 101 shown in FIG. 1 is in the form of a flat plate, the shape of the body is not limited thereto. For example, the body 101 may have a shape in which the left end and the right end protrude forward and the central portion is curved so as to be concave.

The screen 102 is formed on the front surface of the body 101, and the screen 102 may display the image corresponding to visual information. For example, the screen 102 may display a still image or a moving image, and further display a two-dimensional plane image or a three-dimensional image using binocular disparity.

A plurality of pixels P may be formed on the screen 102 and an image displayed on the screen 102 may be formed by a combination of the lights emitted from the plurality of pixels P. For example, a single still image may be formed on the screen 102 by combining the light emitted by the plurality of pixels P as a mosaic.

Each of the plurality of pixels P may emit light of various brightness and various colors. For example, the plurality of pixels P may include a red pixel R, a green pixel G, and a blue pixel B to form an image in various colors. In this case, the red pixel R may emit red light of various brightness, the green pixel G may emit green light of various brightness, and the blue pixel B may emit blue light of various brightness. For example, the red light may represent a light beam having a wavelength of approximately 620 nanometers (nm) to 750 nm, the green light may represent a light beam having a wavelength of approximately 495 nm to 570 nm, and the blue light may represent a light beam having a wavelength of approximately 450 nm to 495 nm.

By combining the red light of the red pixel R, the green light of the green pixel G and the blue light of the blue pixel B, each of the plurality of pixels P may emit light of various brightness and various colors.

The support 103 is installed or provided under the body 101 so that the body 101 may stably maintain its position on the floor. Alternatively, the support 103 may be provided on the rear side of the body 101 so that the body 101 may be firmly fixed to the wall.

Although the support 103 shown in FIG. 1 has a bar shape protruding from the lower side of the body 101 to the front side, the shape of the support 103 is not limited thereto. That is, the support 103 may have a variety of shapes as long as stably supporting the body 101.

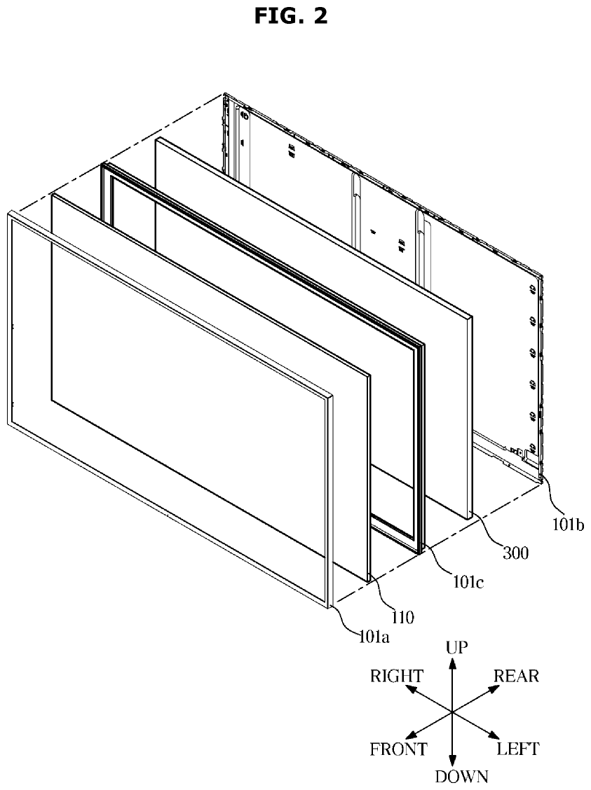

FIG. 2 is an exploded view illustrating a display apparatus 100 according to an embodiment.

As shown in FIG. 2, in the body 101, various components for generating the image I on the screen 102 may be provided. In particular, the body 101 may include a backlight unit 300 emitting surface light, and an image generator 110 generating an image by transmitting or blocking light emitted from the backlight unit 300.

The body 101 may include a front chassis 101a, a rear chassis 101b, and a mold frame 101c to fix the image generator 110 and the backlight unit 300.

The front chassis 101a may have a shape of a plate having an opening formed at a front surface thereof. A user may view an image generated by the image generator 110 through the opening in front of the front chassis 101a.

The rear chassis 101b has a box shape having an open front surface and accommodates the image generator 110 and the backlight unit 300 constituting the display apparatus 100.

The mold frame 101c may be arranged between the front chassis 101a and the rear chassis 101b. In particular, the mold frame 101c may be provided between the image generator 110 and the backlight unit 300 to fix the image generator 110 and the backlight unit 300, respectively.

The backlight unit 300 may include a point light source that emits monochromatic light or white light, and may refract, reflect, and scatter light to convert light emitted from the point light source into uniform surface light. Accordingly, the backlight unit 300 may emit uniform surface light toward the front by refracting, reflecting, and scattering the light emitted from the light source.

A configuration and operation of the backlight unit 300 is described in detail below.

The image generator 110 is provided in front of the backlight unit 300 and blocks or transmits light emitted from the backlight unit 300 to form an image.

The front surface of the image generator 110 forms the screen 102 of the display apparatus 100 described above and may be composed of a plurality of pixels P.

The plurality of pixels P contained in the image generator 110 may independently block or transmit the light of the backlight unit 300, and the light transmitted by the plurality of pixels P may form an image to be displayed on the display apparatus 100.

The image generator 110 may use a liquid crystal panel in which optical properties thereof change according to an electric field.

Hereinafter, the liquid crystal panel will be described as an example of the image generator 110.

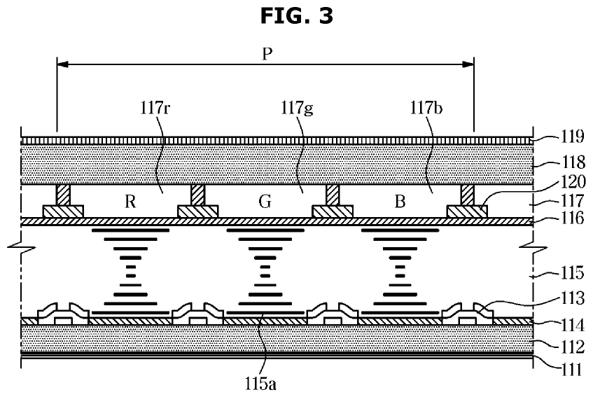

FIG. 3 is a side cross-sectional view illustrating a single pixel P contained in an image generator 110 of a display apparatus 100 according to an embodiment.

As illustrated in FIG. 3, the image generator 110 may include a first polarizing film 111, a first transparent substrate 112, a thin film transistor 113, a pixel electrode 114, a liquid crystal layer 115, a common electrode 116, a color filter 117, a second transparent substrate 118, and a second polarizing film 119. The liquid crystal panel according to an embodiment may be defined as a liquid crystal panel including the first transparent substrate 112, the thin film transistor 113, the pixel electrode 114, the liquid crystal layer 115, the common electrode 116, the color filter 117, and the second transparent substrate 118.

The first transparent substrate 112 and the second transparent substrate 118 may form an appearance of the image generator 110, and may protect the liquid crystal layer 115 and the color filter 117 arranged between the first transparent substrate 112 and the second transparent substrate 118. The first transparent substrate 112 and the second transparent substrate 118 may be formed of tempered glass or transparent resin.

The first polarizing film 111 and the second polarizing film 119 are provided outside the first transparent substrate 112 and the second transparent substrate 118.

The light may be a pair of an electric field and a magnetic field that oscillate in a direction perpendicular to the traveling direction. The electric field and the magnetic field may oscillate in all directions orthogonal to the traveling direction of light. In this case, the phenomenon in which the electric field or the magnetic field oscillates only in a specific direction is called polarization, and a film configured to transmit light including the electric field and the magnetic field oscillating in a predetermined direction and configured to block light including the electric field and the magnetic field oscillating in a direction other than the predetermined direction is referred to as a polarizing film. In other words, the polarizing film may transmit light oscillating in a predetermined direction and block light oscillating in another direction.

The first polarizing film 111 transmits light having an electric field and a magnetic field oscillating in a first direction and blocks other light. In addition, the second polarizing film 119 transmits light having an electric field and a magnetic field oscillating in a second direction and blocks other light. At this time, the first direction and the second direction may be orthogonal to each other. In other words, the polarizing direction of the light transmitted by the first polarizing film 111 and the oscillating direction of the light transmitted by the second polarizing film 119 are orthogonal to each other. As a result, generally, light may not pass through both the first polarizing film 111 and the second polarizing film 119 at the same time.

The color filter 117 may be provided inside the second transparent substrate 118.

The color filter 117 may include a red filter 117r transmitting red light, a green filter 117g transmitting green light, and a blue filter 117b transmitting blue light, and the red filter 117r, the green filter 117g and the blue filter 117b may be arranged parallel to each other. The color filter 117 may include a black matrix 120 configured to prevent color interference between the red filter 117r, the green filter 117g and the blue filter 117b, and configured to block light of the backlight unit 300 to prevent light from being leaked toward other parts except for the red filter 117r, the green filter 117g and the blue filter 117b. The black matrix 120 is arranged between the red filter 117r, the green filter 117g, and the blue filter 117b.

A region in which the color filter 117 is formed or provided corresponds to the pixel P described above. In addition, a region in which the red filter 117r is formed or provided corresponds to the red pixel R, a region in which the green filter 117g is formed or provided corresponds to the green pixel G, and a region in which the blue filter 117b is formed or provided corresponds to the blue pixel B. In other words, the red filter 117r, the green filter 117g, and the blue filter 117b form the red pixel R, the green pixel G, and the blue pixel B. The pixel P is formed by the combination of the red filter 117r, the green filter 117g, and the blue filter 117b.

The thin film transistor (TFT) 113 is provided on the inner side of the first transparent substrate 112.

In particular, the thin film transistor 113 may be formed at a position corresponding to between the red filter 117r, the green filter 117g, and the blue filter 117b. In other words, the thin film transistor 113 may be positioned between the red pixel R, the green pixel G, and the blue pixel B.

The thin film transistor 113 may transmit or block the current flowing through the pixel electrode 114, described below. For example, an electric field may be formed or removed between the pixel electrode 114 and the common electrode 116 in accordance with the turning on (closing) or turning off (opening) of the thin film transistor 113. The thin film transistor 113 may be composed of a poly-silicon, and the thin film transistor 113 may be formed by a semiconductor process such as lithography, deposition, or ion implantation process.

The pixel electrode 114 may be provided on the inner side of the thin film transistor 113 of the first transparent substrate 112. The common electrode 116 may be provided on the inner side of the color filter 117 of the second transparent substrate 118.

The pixel electrode 114 and the common electrode 116 are formed of a conductive metal and may generate an electric field for changing the arrangement of liquid crystal molecules 115a forming the liquid crystal layer 115 described below.

The pixel electrode 114 may be formed or provided in a region corresponding to the red filter 117r, the green filter 117g, and the blue filter 117b, and the common electrode 116 may be formed or provided on the entire panel. As a result, an electric field may be selectively formed in a region corresponding to the red filter 117r, the green filter 117g, and the blue filter 117b, in the liquid crystal layer 25.

The pixel electrode 114 and the common electrode 116 may be formed of or include a transparent material and transmit light incident from the outside. For example, the pixel electrode 114 and the common electrode 116 may be formed of at least one of indium tin oxide (ITO), indium zinc oxide (IZO), Ag nano wire, a carbon nano tube (CNT), or graphene, 3,4-ethylenedioxythiophene (PEDOT).

The liquid crystal layer 115 is formed or provided between the pixel electrode 114 and the common electrode 116, and the liquid crystal layer 115 includes the liquid crystal molecules 115a.

The liquid crystal represents an intermediate state between a solid (crystal) and a liquid. In general, when a solid material is heated, the state changes from a solid state to a transparent liquid state at the melting temperature. On the other hand, when a liquid crystal material in a solid state is heated, the liquid crystal material changes into an opaque and turbid liquid at the melting temperature and then changes to a transparent liquid state. The term “liquid crystal” refers to a liquid crystal state that is an intermediate state between a solid phase and a liquid phase or may refer to a material having such a liquid crystal state itself.

Most of such liquid crystal materials are organic compounds, and their molecular shapes are elongated and rod-shaped, and the arrangement of molecules is the same as an irregular state in any direction, but may have a regular crystalline form in the other direction. As a result, the liquid crystal has both fluidity of liquid and optical anisotropy of crystal (solid).

The liquid crystal may also have optical properties depending on the change of the electric field. For example, the direction of the molecular arrangement of the liquid crystal may change depending on the change of the electric field. When an electric field is generated in the liquid crystal layer 115, the liquid crystal molecules 115a of the liquid crystal layer 115 may be arranged in the direction of the electric field. Conversely, when no electric field is generated in the liquid crystal layer 115, the liquid crystal molecules 115a may be arranged irregularly or arranged along an alignment layer.

As a result, the optical properties of the image generator 110 may vary depending on the presence of an electric field in the liquid crystal layer 115.

For example, when the electric field is not formed or provided in the liquid crystal layer 115, the light polarized by the first polarizing film 111 may pass through the second polarizing film 119 due to the arrangement of the liquid crystal molecules 115a of the liquid crystal layer 115. In other words, the light may pass through the image generator 110, particularly, only a pixel P in which the electric field is not formed, in the liquid crystal layer 115.

On the other hand, when an electric field is formed in the liquid crystal layer 115, light polarized by the first polarizing film 111 does not pass through the second polarizing film 119 due to the arrangement of the liquid crystal molecules 115a of the liquid crystal layer 115. In other words, light is blocked by the image generator 110, in particular, a pixel P in which the electric field is formed, in the liquid crystal layer 115.

As mentioned above, the image generator 110 may control the light transmission independently of each pixel P (more specifically, a red pixel, a green pixel, and a blue pixel contained in the pixel). As a result, light of the plurality of pixels P may be combined and thus an image may be displayed on the screen 102 of the display apparatus 100.

Hereinafter, the backlight unit 300 will be described in detail.

The backlight unit 300 may be classified into a direct-type backlight unit and an edge-type backlight unit according to the position of the light source.

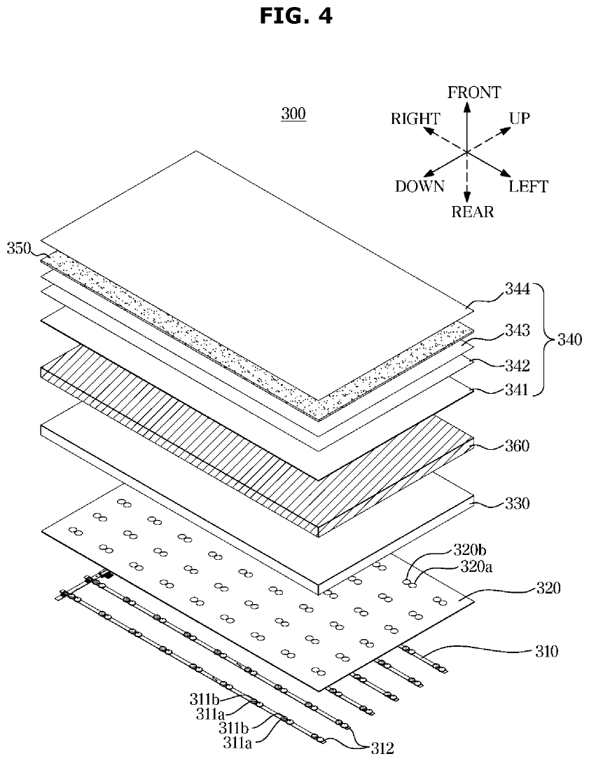

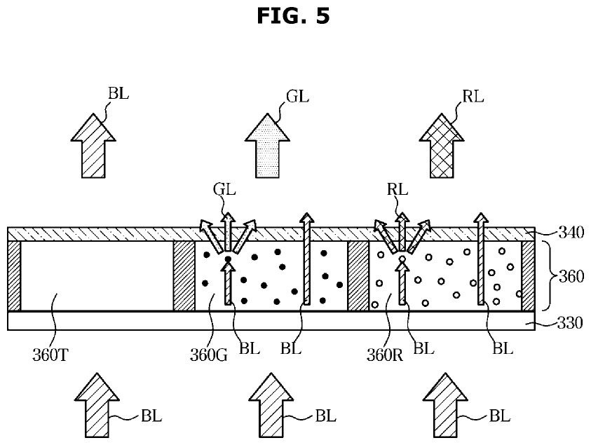

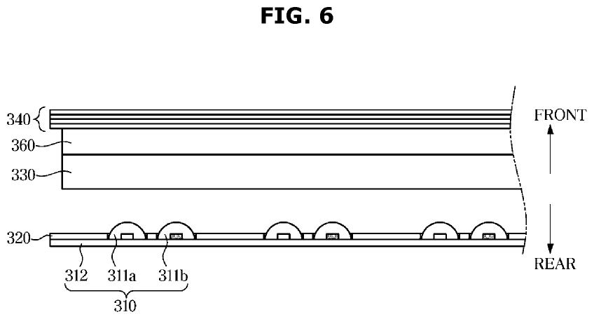

FIG. 4 is an exploded view illustrating a backlight unit 300 according to an embodiment. FIG. 5 is a view illustrating an internal configuration of a quantum dot color filter layer 360 according to an embodiment. FIG. 6 is a side cross-sectional view illustrating a backlight unit 300 according to an embodiment.

Referring to FIGS. 4 to 6, a direct type backlight unit 300 includes a light emitting module 310 (e.g., light emitter) generating light, a reflective sheet 320 reflecting the light, a diffuser plate 330 diffusing the light, a quantum dot color filter layer 360 converting color of the light irradiated from the light source, and an optical sheet 340 improving light brightness.

The light emitting module 310 may include a plurality of light sources 311 emitting light and a support 312 supporting and/or fixing the plurality of light sources 311.

According to the present embodiment, the plurality of light sources 311 of the backlight unit 300 may include a first light source 311a emitting first light and a second light source 311b emitting second light.

In the related art, a plurality of light sources 311 provided in a backlight unit 300 is composed of a single light source that emits light of a specific short wavelength. Therefore, when light emitted from the single light source passes through a quantum dot color filter layer 360 and color thereof is converted, color reproducibility is determined according to its own characteristics of the quantum dot and, thus, the display apparatus 100 has a limitation in implementing various and deep color images.

Meanwhile, the backlight unit 300 according to an embodiment may include two different light sources 311a and 311b to allow light of different wavelengths to be emitted.

For example, a first light source 311a may emit blue light, and a second light source 311b may emit ultraviolet light having a shorter wavelength than blue light. In this case, the wavelength of the blue light emitted by the first light source 311a may be 440 nm to 450 nm, and the wavelength of the ultraviolet light emitted by the second light source 311b is shorter and thus the ultraviolet light has energy higher than the energy of the blue light.

Accordingly, when light having a relatively short wavelength and relatively high energy is emitted from the light source 311, the energy absorbed by the quantum dot color filter layer 360 is high, and thus the energy emitted from the quantum dot color filter layer 360 is also high. Therefore, color reproducibility may be improved.

That is, when a bright and clear image is required or desired to be displayed on the display apparatus 100 based on an image signal input from the outside, the second light source 311b having a short wavelength and high energy emits light and thus the intensity of the light representing green and red may be increased through the quantum dot color filter layer 360. Therefore, it is possible to implement a deep and vivid color.

As mentioned above, using the backlight unit 300 and the display apparatus 100 including the same according to an embodiment, it is possible to select a type of light source emitting light, based on brightness of an image signal input from the outside. As a result, color reproducibility of the display apparatus 100 may be improved and a user can be provided with high color with a maximum contrast ratio.

The first light source 311a and the second light source 311b included in the plurality of light sources 311 may be uniformly arranged at the rear (e.g., rearmost point or area) of the backlight unit 300 and may be configured to emit light to the front, as illustrated in FIG. 4.

As illustrated in FIG. 4, the first light source 311a and the second light source 311b may be provided in plural, and there is no limit to the number of the first light source 311a and the second light source 311b arranged on the support 312.

In addition, the first light source 311a and the second light source 311b may be spaced apart from each other on the support 312 by a predetermined distance.

The first light source 311a and the second light source 311b may be arranged in a predetermined pattern to allow the light emitted from the first light source 311a and the second light source 311b to have the uniform brightness as much as possible.

In particular, the first light source 311a may be arranged in such a way that a distance between the plurality of first light sources 311a is the same. For example, as illustrated in FIG. 4, rows and columns of the plurality of first light sources 311a may be aligned to form a square by four adjacent first light sources 311a. However, the pattern in which the plurality of first light sources 311a is arranged is not limited to the above-described square pattern, and the plurality of first light sources 311a may be arranged in various patterns in various embodiments to allow light emitted from the plurality of first light sources 311a to have the uniform brightness as much as possible.

Similarly, the second light source 311b may be arranged in such a way that a distance between the plurality of second light sources 311b is the same. For example, as illustrated in FIG. 4, rows and columns of the plurality of second light source 311b may be aligned to form a square by four adjacent second light sources 311b. However, the pattern in which the plurality of second light source 311b are arranged is not limited to the above-described square pattern, and the plurality of second light sources 311b may be arranged in various patterns in various embodiments to allow light emitted from the plurality of second light sources 311b to have the uniform brightness as much as possible.

The first light source 311a and the second light source 311b may employ an element configured to emit monochromatic light (light having a specific wavelength, for example, blue light) or white light (i.e., light mixed with light of various wavelengths) in various directions based on electric power being supplied.

As described in the example above, the first light source 311a may be configured emit blue light and the second light source 311b may be configured to emit ultraviolet light having a shorter wavelength than blue light.

The support 312 may fix the plurality of first light sources 311a and the plurality of second light sources 311b so that the positions of the light sources 311 are not changed. In addition, the support 312 may supply power to each light source 311 so that each first light source 311a and each second light source 311b emit light.

In addition, the support 312 may be provided in plural according to the arrangement of the plurality of first light sources 311a and the plurality of second light sources 311b. For example, as illustrated in FIG. 4, when the plurality of first light sources 311a and the plurality of second light sources 311b are arranged in rows, the number of provided supports 312 may be identical to the number of rows of the plurality of first light sources 311a and the plurality of second light sources 311b. The plurality of supports 312 may each fix the plurality of first light sources 311a and the plurality of second light sources 311b contained in the same row. The support 312 may be composed of or include a synthetic resin, on which a conductive power supply line is formed, to supply power to the plurality of first light sources 311a and the plurality of second light sources 311b and/or a printed circuit board (PCB).

The reflective sheet 320 may be arranged in front of the light emitting module 310, and may reflect light, which travels toward the rear, to the front or a direction close to the front.

On the reflective sheet 320, a plurality of first through holes 320a may be formed at a position corresponding to the plurality of first light sources 311a, and a plurality of second through holes 320b may be formed at a position corresponding to the plurality of second light sources 311b.

In addition, the first light source 311a and the second light source 311b may pass through the first through hole 320a and the second through hole 320b, respectively, and then protrude to the front of the reflective sheet 320, as illustrated in FIG. 6.

The reflective sheet 320 may be manufactured by coating a base material with a material having a high reflectance. For example, the reflective sheet 320 may be manufactured by coating a base material such as polyethylene terephthalate (PET) with a polymer having a high reflectance.

The diffuser plate 330 may be arranged in front of the light emitting module 310 and the reflective sheet 320, and may evenly distribute light emitted from the first light source 311a and the second light source 311b.

Although the first light source 311a and the second light source 311b are arranged at equal intervals, unevenness in the brightness may occur according to the positions of the first light source 311a and the second light source 311b. The diffuser plate 330 may diffuse the light emitted from the first light source 311a and the second light source 311b to remove the unevenness in the brightness caused by the first light source 311a and the second light source 311b. In other words, the diffuser plate 330 may receive non-uniform light from the first light source 311a and the second light source 311b and emit uniform light to the front side.

The diffuser plate 330 may employ a poly methyl methacrylate (PMMA) or a polycarbonate (PC) to which a diffusion agent for light diffusion is added.

The optical sheet 340 may include various sheets for improving brightness and uniformity of brightness. For example, the optical sheet 340 may include a diffusion sheet 341, a first prism sheet 342, a protective sheet 343, and a brightness enhancement sheet 344.

The diffusion sheet 341 diffuses light for uniformity of brightness. Light emitted from the first light source 311a and the second light source 311b may be diffused by the diffusion sheet 341 contained in the optical sheet 340.

According to another embodiment, instead of the diffusion sheet 341, a micro-lens sheet configured to diffuse light and widen the viewing angle may be used or provided.

Light transmitted through the diffusion sheet 341 is spread in a direction in parallel with the diffusion sheet 341, and thus brightness may be reduced.

The prism sheet 342 increases the brightness by condensing the light diffused by the diffusion sheet 341.

The prism sheet 342 includes a prism pattern having a triangular prism shape, and a plurality of prism patterns is arranged adjacent to each other to form a plurality of strips. The prism sheet may include a first prism sheet and a second prism sheet. A direction in which the prism pattern of the first prism sheet is arranged and a direction in which the prism pattern of the second prism sheet is arranged may be perpendicular to each other.

The light transmitted through the prism sheet 342 has a viewing angle of approximately 70 degrees, and travels forward of the backlight unit 300, thereby improving the brightness.

The protective sheet 343 protects various components contained in the backlight unit 300 from external impact or foreign substances. In particular, the prism sheet 342 is vulnerable to scratches, and thus the protective sheet 243 may prevent scratching of the prism sheet 342.

The brightness enhancement sheet 344 is a kind of polarizing film and is also referred to as a reflective polarizing film. The brightness enhancement sheet may transmit some of the incident light beams and reflect other beams for improving the brightness. For example, the brightness enhancement sheet 344 may transmit light beams in a predetermined polarization direction and reflect other light beams. In this case, the polarization direction of the brightness enhancement sheet 344 may be the same as the polarization direction of the first polarizing film 111 described above. As a result, the light transmitted through the brightness enhancement sheet 344 may also be transmitted through the first polarizing film 111 contained in the image generator 110.

In addition, the light reflected by the brightness enhancement sheet 344 is recycled in the backlight unit 300, thereby improving the brightness of the display apparatus 100.

The optical sheet 340 is not limited to the sheet or film illustrated in FIG. 4, and may include more various sheets or films in various embodiments.

The quantum dot color filter layer 360 is arranged between the diffuser plate 330 and the optical sheet 340.

Referring to FIG. 5, the quantum dot color filter layer 360 may include a red light converter 360R converting incident light to red light using a quantum dot, a green light converter 360G converting incident light to green light using a quantum dot, and a light transmitter 360T transmitting incident light. The order in which the respective converters and the transmitter are arranged may vary from the example of FIG. 5 in various embodiments.

Light, which is emitted from at least one of the first light source 311a or the second light source 311b and incident on the quantum dot color filter layer 360, is converted into red light RL by the red light converter 360R, or is converted into the green light GL by the green light converter 360G. Light incident on the light transmitter 360T may be transmitted without color conversion.

For example, blue light BL, which is emitted from the first light source 311a and incident on the quantum dot color filter layer 360, is converted into red light RL by the red light converter 360R or into green light GL by the green light converter 360G. The blue light BL incident on the light transmitter 360T is transmitted without color conversion.

The light transmitted through the quantum dot color filter layer 360 or the light in which color is converted by the quantum dot color filter layer 360 may be incident on the optical sheet 340 arranged on the front side of the quantum dot color filter layer 360. As a result, the light emitted to the outside by the image generator 110 may be displayed as an image for a viewer.

The red light converter 360R and the green light converter 360G may respectively convert the color of the light using quantum dots. The light transmitter 360T may be empty to allow incident light to be transmitted without change, or may be formed of a transparent resin such as acryl-nitrile butadiene styrene (ABS), poly methyl methacrylate (PMMA), and polycarbonate (PC).

The quantum dot refers to a small sphere-shaped semiconductor particle of nanometer size, and may be composed of a core of several nanometers to tens of nanometers in size and a shell composed of zinc sulfide (ZnS). The core of the quantum dot may be formed of cadmium selenite (CdSe), cadmium telluride (CdTe), or cadmium sulfide (CdS).

Thus, the quantum confinement effect occurs because the quantum dots are very small in size. The quantum confinement effect represents that electrons in a particle form a discontinuous energy state due to the outer wall of the particle when the particle is very small and as the space in the particle becomes smaller, the energy state of the electron becomes relatively higher and the energy band gap becomes wider. According to such a quantum confinement effect, a quantum dot can generate light in a wide range of wavelengths when light such as ultraviolet rays or visible light is incident.

The wavelength of the light generated in the quantum dot may vary in accordance with the particle size. Particularly, when light having a wavelength greater than the energy band gap is incident on the quantum dot, the quantum dot absorbs the energy of the light and is excited, and becomes a ground state while emitting light of a specific wavelength. As the size of the quantum dots is small, the quantum dots generate light having a relatively short wavelength such as blue-based light or green-based light. As the size of the quantum dots is big, the quantum dots generate light having a relatively long wavelength such as red-based light. Therefore, it is possible to implement light of various colors according to the size of the quantum dot.

Quantum dot particles capable of emitting green-based light are referred to as green quantum dot particles, and quantum dot particles capable of emitting red-based light are referred to as red quantum dot particles.

For example, a green quantum dot particle may be a particle having a width of about 2 nm to about 3 nm, and a red quantum dot particle may be a particle having a width of about 5 nm to about 6 nm.

Referring to FIG. 5, the red light converter 360R may include red light quantum dot particles, and the green light converter 360G may include green light quantum dot particles. For example, the red light converter 360R may be formed in such a way that red light quantum dot particles are dispersed in a resin, and the green light converter 360G may be formed in such a way that green light quantum dot particles are dispersed in a resin.

Meanwhile, a partition wall may be provided to distinguish each cell forming the red light converter 360R, the green light converter 360G, and the light transmitting part 360T. The partition wall may be a black matrix. The partition wall may prevent the movement of light between the cells and improve the contrast.

The red light converter 360R, the green light converter 360G, and the light transmitter 360T may form a single pixel P. The single pixel P composed of the red light converter 360R, the green light converter 360G and the light transmitter 360T may be arranged in two dimensions to implement a color of a two-dimensional image.

As described above, when light having a short wavelength and high energy is emitted from the light source, energy absorbed by the quantum dot color filter layer 360 may be high and thus energy emitted from the quantum dot color filter layer 360 may be also high. Therefore, it is possible to improve color reproducibility of the display apparatus 100.

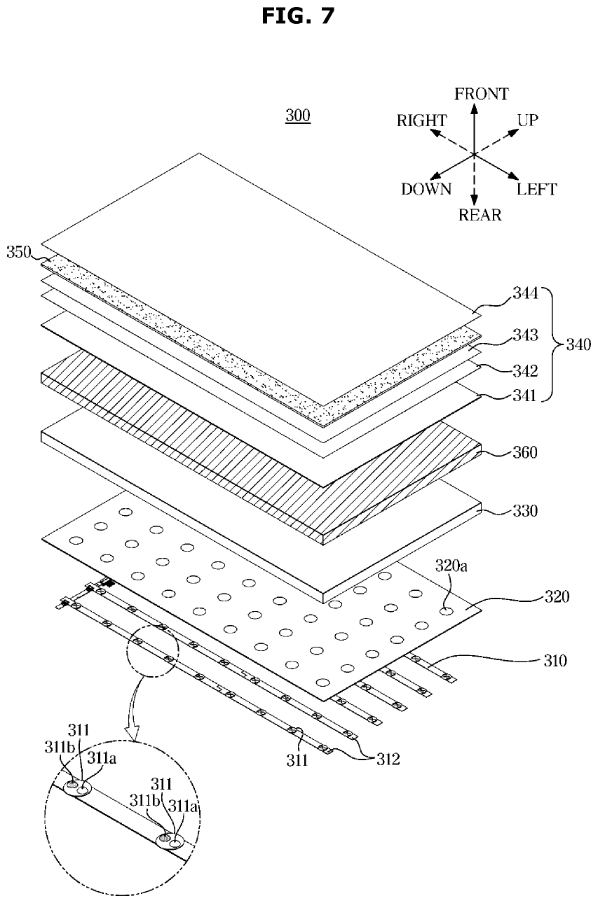

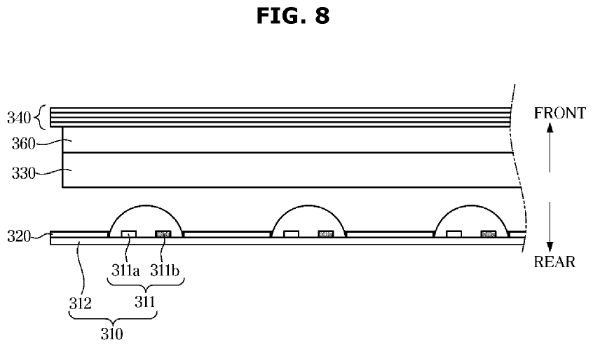

FIG. 7 is an exploded view illustrating a backlight unit according to another embodiment. FIG. 8 is a side cross-sectional view illustrating a backlight unit according to another embodiment.

Referring to FIG. 7, an arrangement of a first light source 311a and a second light source 311b may be different from that of the arrangement shown in FIG. 4.

That is, although the first light source 311a and the second light source 311b illustrated in FIGS. 4 and 6 are spaced apart from each other along the support 312 by a predetermined distance, the first light source 311a and the second light source 311b illustrated in FIGS. 7 and 8 may be implemented in such a way that the first light source 311a and the second light source 311b are contained in a single light source 311.

The plurality of light sources 311 including the first light source 311a and the second light source 311b may be arranged on a support 312 according to a predetermined pattern.

In particular, the light sources 311 may be arranged to have the same distance between the plurality of light sources 311. For example, as illustrated in FIG. 7, rows and columns of the plurality of light sources 311 may be aligned to form a square by four adjacent light sources 311. However, it is understood that the pattern in which the plurality of light sources 311 are arranged is not limited to the square pattern described above, and the plurality of light sources 311 may have various patterns in various embodiments to allow the light emitted from the plurality of light sources 311 to have uniform brightness as much as possible.

The first light source 311a contained in the light source 311 may emit blue light, and the second light source 311b contained in the light source 311 may emit ultraviolet light.

A plurality of through holes 320a may be formed on a reflective sheet 320 at positions corresponding to the plurality of light sources 311.

The through hole 320a illustrated in FIG. 7 may be implemented as a hole having a larger area than the first through hole 320a and the second through hole 320b illustrated in FIG. 4. That is, referring to FIG. 8, the light source 311 including the first light source 311a and the second light source 311b may protrude toward the reflective sheet 320 by passing through the through hole 320a of the reflective sheet 320.

As described above, the first light source 311a and the second light source 311b contained in the backlight unit 300 according to an embodiment may be implemented in the form illustrated in FIG. 4 or FIG. 7, but is not limited thereto. Therefore, the first light source 311a and the second light source 311b may be implemented in various forms in various embodiments.

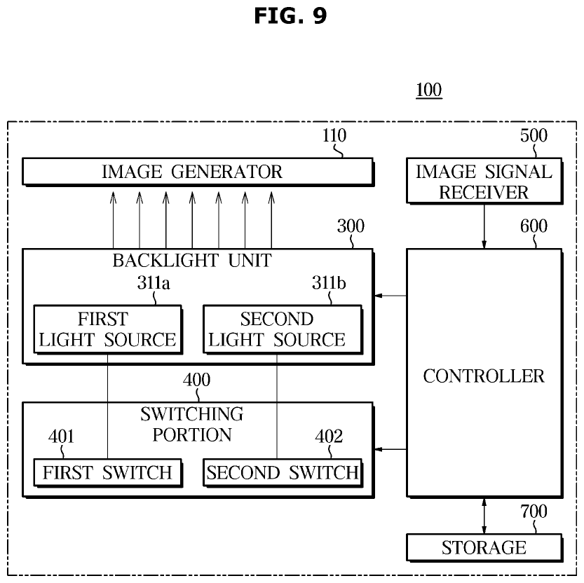

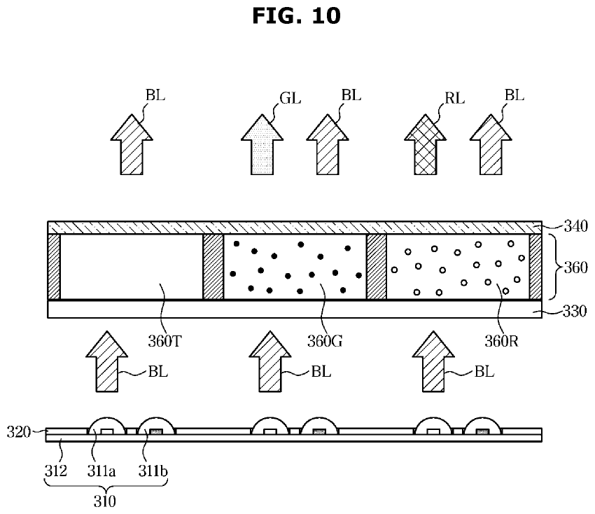

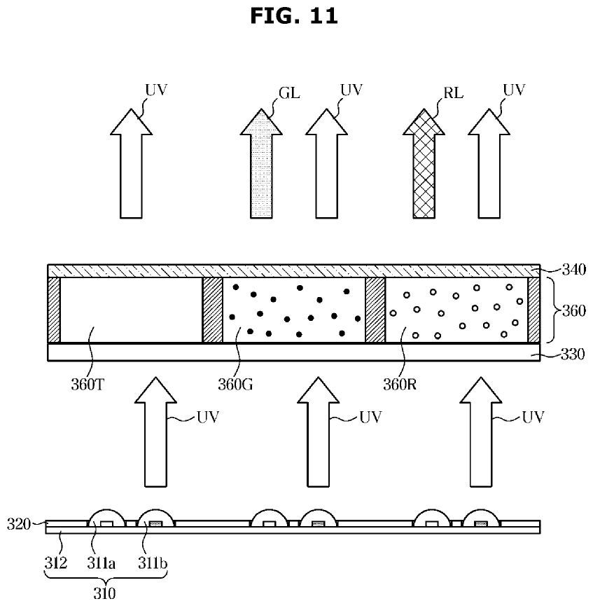

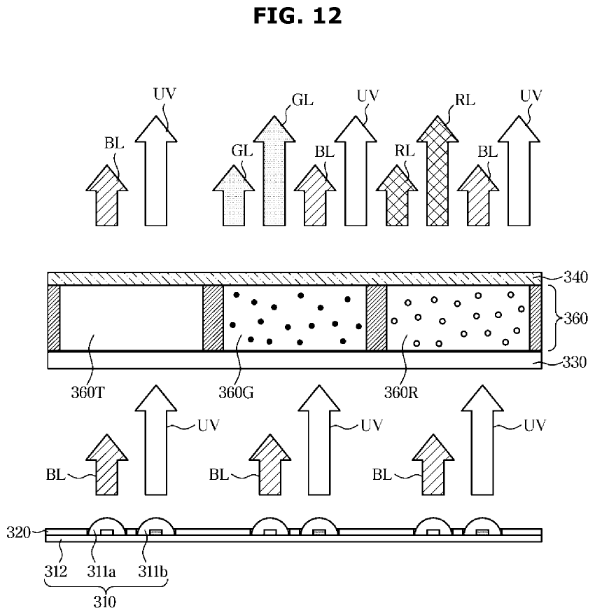

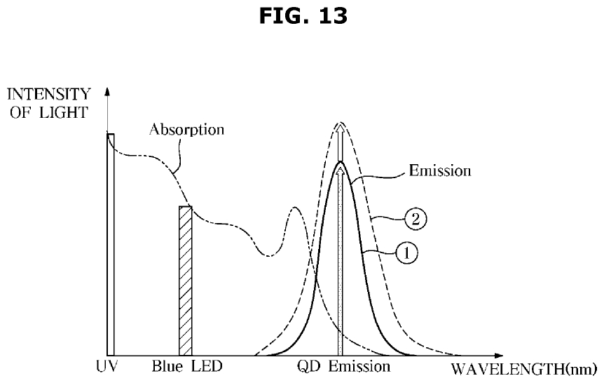

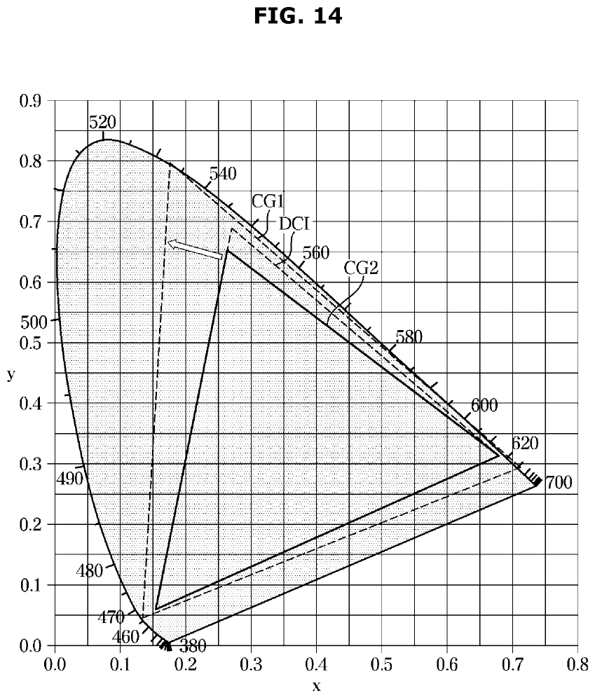

FIG. 9 is a control block diagram of a display apparatus 100 according to an embodiment. FIG. 10 is a view illustrating a state in which a first light source 311a emits first light according to an embodiment, and FIG. 11 is a view illustrating a state in which a second light source 311b emits second light according to an embodiment. FIG. 12 is a view illustrating a state in which a first light source 311a and a second light source 311b simultaneously emit first light and second light, respectively, according to an embodiment. FIG. 13 is a view illustrating a spectrum in which a quantum dot color filter layer 360 absorbs and emits first light and second light, according to an embodiment, and FIG. 14 is a view illustrating a change in a color gamut of a display apparatus 100 according to an embodiment.

Referring to FIG. 9, the display apparatus 100 according to an embodiment include an image generator 110, a backlight unit 300, a switching portion 400, an image signal receiver 500, a controller 600, and a storage 700.

The image generator 110 may generate an image by transmitting or blocking light emitted from the backlight unit 300.

The backlight unit 300 may include a first light source 311a emitting first light and a second light source 311b emitting second light.

As described above, the first light source 311a may emit blue light BL, and the second light source 311b may emit ultraviolet light UV having a shorter wavelength than blue light. For example, the wavelength of the blue light emitted by the first light source 311a may be 440 nm to 450 nm, and the wavelength of the ultraviolet light emitted by the second light source 311b is shorter and thus the ultraviolet light has energy higher than that of the blue light.

The switching portion 400 may include a first switch 401 configured to operate the first light source 311a to allow the first light source 311a to emit first light and a second switch 402 configured to operate the second light source 311b to allow the second light source 311b to emit second light.

The first switch 401 may turn the first light source 311a on or turn off, and the second switch 402 may turn the second light source 311b on or turn off.

The first switch 401 and the second switch 402 are connected to the support 312, which may be implemented as a printed circuit board (PCB), to operate the first light source 311a and the second light source 311b. Alternatively, the first switch 401 and the second switch 402 may be directly connected to the first light source 311a and the second light source 311b, respectively, to control the turning on or off of the first light source 311a and the second light source 311b.

The switching portion 400 including the first switch 401 and the second switch 402 may be a wiring element that connects or blocks a current in an electric and electronic device. For example, the switching portion 400 may include a transistor for connecting a current according to a control signal, a bipolar junction transistor (BJT) and a field effect transistor (FET), but is not limited thereto.

In an embodiment in which the switching portion 400 operates as a field effect transistor (FET), it is understood that the switching portion 400 may include a gate terminal, a drain terminal, and a source terminal. The drain terminal may function as the source terminal, and the source terminal may function as the drain terminal according to an input signal.

In addition, the switching portion 400 may be classified into a low voltage switching element LN operating at a low voltage and a high voltage switching element HN operating at a high voltage according to the operating voltage. In particular, the high voltage switching element HN is a switching element that is capable of withstanding a high voltage, even the high voltage applied to a drain terminal, and is commonly used in various power devices.

The high voltage switching element includes double-diffused MOSFET (DMOSFET), insulated gate bipolar transistors (IGBT), extended drain MOSFET (EDMOSFET), lateral double-diffused MOSFET (LDMOSFET), and gallium nitride (GaN) transistor, but is not limited thereto.

In addition, in an embodiment, “turn on” means changing the switching element from a non-conductive state to a conductive state. In particular, to “turn on” the switching element means supplying a signal to the gate so that a current flows through the switching element. On the other hand, “turn off” means changing the switching element from the conductive state to the non-conductive state.

The image signal receiver 500 may receive an image signal input to the display apparatus 100.

That is, the image signal receiver 500 may receive a signal for an image source input from outside or a pre-stored image content for an image to be output on the display apparatus 100.

The image signal receiver 500 may extract broadcast signals for specific frequencies among various signals received through an antenna cable provided in the display apparatus 100, and may appropriately convert the extracted broadcast signals.

The image signal receiver 500 may wirelessly receive the image signal, convert the received image signal appropriately, and display the image on the display apparatus 100. The image signal received by the image signal receiver 500 may be a signal including broadcast data related to a broadcast program, or may be image content stored in a set top box.

The image signal may be transmitted after being modulated and compressed by various methods. The image signal may include one piece of channel information or may include a plurality piece of channel information. According to an embodiment, the image signal may be a signal of a single carrier according to an Advanced Television Systems Committee (ATSC) scheme or a signal of multiple carriers according to a Digital Video Broadcasting (DVB) scheme.

The DVB scheme includes various known schemes such as a digital video broadcaster-terrestrial version (DVB-T) and a digital video broadcaster-terrestrial version T2 (DVB-T2). However, the image signal is not limited to the above-described examples, and may include all signals including image content according to various methods and schemes.

The image signal received by the image signal receiver 500 may include a signal indicating that a brightness of the image signal is high, or a signal indicating that a brightness of the image signal is low.

That is, when the display apparatus 100 implements an image displayed on the display apparatus 100 based on the received image signal, the display apparatus 100 may distinguish between a high gradation image signal for outputting a bright and clear image and a low gradation image for outputting a dark and dim image, and then outputs a corresponding image accordingly.

In this case, upon outputting the bright and clear image, a brightness value of green and red color output from the quantum dot color filter layer 360 is made to be large by controlling light emitted from the backlight unit 300 based on a brightness value of an image signal received by the 500. Upon outputting the dark and dim image, a brightness value of green and red color output from the quantum dot color filter layer 360 is made to be small by controlling light emitted from the backlight unit 300 based on a brightness value of an image signal received by the 500.

That is, because it is possible to increase the brightness value of the color, which is converted by the quantum dot color filter layer 360, by varying light emitted from the backlight unit 300 according to the brightness value of the received image signal, it is possible to improve the color reproducibility of the display apparatus 100.

Referring to FIG. 9, the display apparatus 100 may include the controller 600 configured to control each component of the display apparatus 100.

Based on the brightness of the image signal received by the image signal receiver 500, the controller 600 may control the switching portion 400 to allow at least one of the first light source 311a and the second light source 311b to emit light.

The controller 600 may analyze the image signal received by the image signal receiver 500 to select a color with a high brightness and a color with a low brightness.

For example, based on the received image signal, the controller 600 may determine whether the green color or the red color contained in an image to be output is to be bright and clear or dark and dim.

The storage 700 may store comparison reference data with respect to brightness values of the image signal received by the image signal receiver 500.

The controller 600 may select the brightness of the image to be output on the display apparatus 100 by comparing the brightness value of the received image signal with reference data stored in the storage 700.

The storage 700 may be implemented as at least one of a nonvolatile memory device such as a cache, a read only memory (ROM), a programmable ROM (PROM), an erasable programmable ROM (EPROM), an electrically erasable programmable ROM (EEPROM), and a flash memory, or a volatile memory device such as a random access memory (RAM), or a storage medium such as a hard disk drive (HDD) or a CD-ROM, but is not limited thereto. The storage 700 may be a memory implemented as a separate chip from the processor described above with respect to the controller, or may be implemented as a single chip with the processor.

When the brightness of the received image signal is less than a predetermined value (e.g., first predetermined value) based on a result of the determination, the controller 600 may control the first switch 401 to allow the first light source 311a to emit first light.

That is, when the brightness of the image signal to be output on the display apparatus 100 is relatively dark and dim based on the brightness value of the received image signal, the controller 600 may control the first switch 401 to allow the first light source 311a configured to emit blue light BL to be operated.

Referring to FIG. 10, under the control of the first switch 401 of the controller 600, the first light source 311a may emit blue light BL, and the emitted blue light may be incident on the quantum dot color filter layer 360 and then converted into green light and red light. In addition, some of light beams incident on the quantum dot color filter layer 360 may be emitted as blue light without color conversion.

On the other hand, when the brightness of the received image signal is equal to or greater than the predetermined value (e.g., the first predetermined value or a second predetermined value) based on a result of the determination, the controller 600 may control the second switch 402 to allow the second light source 311b to emit second light.

That is, when the brightness of the image signal to be output on the display apparatus 100 is relatively bright and clear based on the brightness value of the received image signal, the controller 600 may control the second switch 402 to allow the second light source 311b configured to emit ultra violet light UV to be operated.

Referring to FIG. 11, under the control of the second switch 402 of the controller 600, the second light source 311b may emit ultra violet light UV, and the emitted ultra violet light may be incident on the quantum dot color filter layer 360 and then converted into green light and red light. In addition, some of light beams incident on the quantum dot color filter layer 360 may be emitted as ultra violet light without change.

In this case, because the ultraviolet light emitted from the second light source 311b has a shorter wavelength and higher energy than that of the blue light emitted from the first light source 311a, the energy absorbed by the quantum dot color filter layer 360 is high and thus the energy, which is color converted and emitted from the quantum dot color filter layer 360, is also high.

That is, because the color of the ultraviolet light emitted from the second light source 311b is converted by the quantum dot color filter layer 360 and thus brighter and clearer green light and red light are output, the controller 600 may allow the high gradation image to be output on the display apparatus 100.

The controller 600 selectively controls the switching of the first switch 401 and the second switch 402 according to the brightness of the image signal to be output on the display apparatus 100 so as to improve the color reproducibility of the image output on the display apparatus 100.

That is, when the brightness of the image signal received by the image signal receiver 500 is less than the predetermined value (e.g., first predetermined value), the controller 600 may control the first switch 401 to allow the first light source 311a to emit blue light and when the brightness of the received image signal is equal to or greater than the predetermined value (e.g., the first predetermined value or a second predetermined value) based on a result of the determination, the controller 600 may control the second switch 402 to allow the second light source 311b to emit ultraviolet light. Accordingly, the controller 600 may adjust the bright and sharpness of the color of the image to be output on the display apparatus 100.

Referring to FIG. 12, the controller 600 simultaneously controls the first switch 401 and the second switch 402 to allow the first light source 311a and the second light source 311b to simultaneously emit the first light and the second light, respectively. That is, based on the image signal received by the image signal receiver 500, when the image, which is to be output on the display apparatus 100, includes blue, the controller 600 may control the first light source 311a to output the blue light.

In other words, the controller 600 simultaneously controls the first light source 311a and the second light source 311b so that the light emitted through the quantum dot color filter layer 360 includes blue light and at the same time, high energy green light and red light is emitted by the ultraviolet light emitted from the second light source 311b.

As illustrated in FIG. 12, the blue light emitted from the first light source 311a may pass through the quantum dot color filter layer 360 and be output as green light and red light having relatively low energy, and the ultraviolet light emitted from the second light source 311b may pass through the quantum dot color filter layer 360 and be output as green light and red light having relatively high energy.

Referring to FIG. 13, it can be seen that the second light emitted from the second light source 311b is more absorbed by the quantum dot color filter layer 360 than the first light emitted from the first light source 311a. That is, because the second light has a shorter wavelength and higher energy than the first light, the energy absorbed by the quantum dot color filter layer 360 is relatively high.

Accordingly, an intensity \textcircled{2} of the light, which is emitted from the second light source 311b and absorbed by the quantum dot color filter layer 360 and then emitted from the quantum dot color filter layer 360, is greater than an intensity CD of the light, which is emitted from the first light source 311a and absorbed by the quantum dot color filter layer 360 and then emitted from the quantum dot color filter layer 360.

As described above, by operating the second light source 311b emitting ultraviolet light having a higher energy than blue light, the color gamut CG of the display apparatus 100 is expanded.

A graph GR shown in FIG. 14 represents a color gamut of the display, an upper portion of the graph GR represents green G, a lower left side of the graph GR represents blue B, and a lower right side of the graph GR represents red color R.

In addition, the color gamut that the display apparatus 100 can reproduce is represented by a triangular shape inside the graph GR.

Referring to FIG. 14, it can be seen that a first color gamut CG1 of the display apparatus 100 according to an embodiment is expanded in comparison with a second color gamut CG2 of the display apparatus 100 related art. The display apparatus 100 according to an embodiment is configured to emit ultraviolet light by selectively controlling the first light source 311a and/or the second light source 311b based on a brightness value of an image signal for an image to be output on the display apparatus 100, and the display apparatus in the related art is configured to use the first light source 311a emitting blue light, regardless of a brightness value of an image signal for an image to be output on the display apparatus 100.

For example, with respect to the color gamut according to the Digital Cinema Instrument (DCI) value corresponding to an index of the color gamut of the display apparatus 100, the display apparatus in the related art secures 95% of the color gamut in comparison with the color gamut according to the DCI value, but the display apparatus 100 according to an embodiment secures 110% of the color gamut in comparison with the color gamut according to the DCI value.

Accordingly, as for the display apparatus 100 according to an embodiment, the second light emitted from the second light source 311b is color-converted by the quantum dot color filter layer 360 and thus the brighter and clearer green light and red light are emitted. Therefore, it is possible to expand the color reproducibility of the image display on the display apparatus 100.

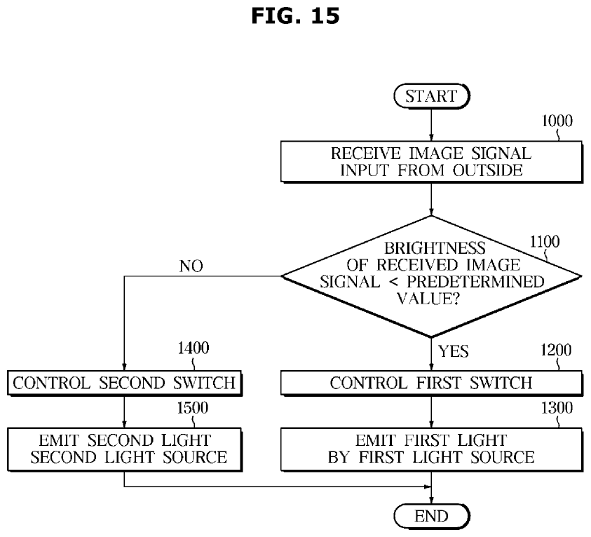

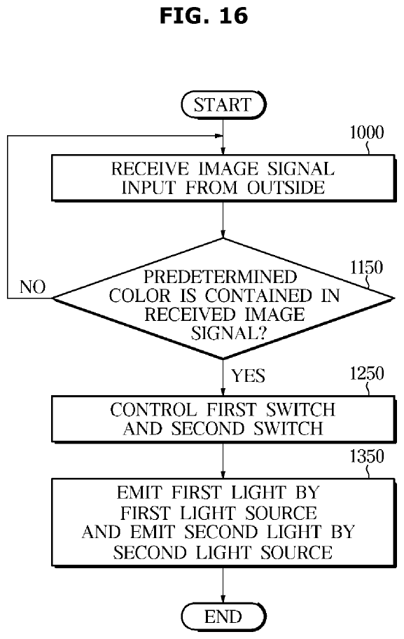

FIGS. 15 and 16 are flowcharts illustrating a control method of the display apparatus according to an embodiment of the disclosure.

Referring to FIG. 15, the image signal receiver 500 may receive an image signal input to the display apparatus 100 from the outside (1000). That is, the image signal receiver 500 may receive a signal for an image source input from outside or a pre-stored image content for the image to be output on the display apparatus 100.

The controller 600 may select (or determine) the brightness of the image to be output on the display apparatus 100 by comparing the brightness value of the image signal received by the image signal receiver 500 with reference data stored in the storage 700.

When (e.g., based on) the brightness of the received image signal is less than a predetermined value (e.g., first predetermined value) based on a result of the comparison, the controller 600 may control the first switch 401 (1200), and the first light source 311a may be turned on by the first switch 401 so as to emit the first light (1300).

That is, under the control of the first switch 401 of the controller 600, the first light source 311a may emit blue light BL, and the emitted blue light may be incident on the quantum dot color filter layer 360 and then converted into green light and red light. In addition, some of light beams incident on the quantum dot color filter layer 360 may be emitted as blue light without color conversion.

When (e.g., based on) the brightness of the received image signal is equal to or greater than the predetermined value (e.g., the first predetermined value or a second predetermined value) based on a result of the comparison, the controller 600 may control the second switch 402 (1400), and the second light source 311b may be turned on by the second switch 402 so as to emit the second light (1500).

That is, under the control of the second switch 402 of the controller 600, the second light source 311b may emit ultra violet light UV, and the emitted ultra violet light may be incident on the quantum dot color filter layer 360 and then converted into green light and red light. In addition, some of light beams incident on the quantum dot color filter layer 360 may be emitted as ultra violet light without change.

Because the ultraviolet light emitted from the second light source 311b has a shorter wavelength and higher energy than the blue light emitted from the first light source 311a, the energy absorbed by the quantum dot color filter layer 360 is high and thus the energy, which is color converted and emitted from the quantum dot color filter layer 360, is also high.

That is, because the color of the ultraviolet light emitted from the second light source 311b is converted by the quantum dot color filter layer 360 and thus brighter and clearer green light and red light are output, the controller 600 may allow the high gradation image to be output on the display apparatus 100.

The controller 600 may determine whether a predetermined color (for example, blue) is contained in the image signal received by the image signal receiver 500 (1150). When (e.g., based on) the predetermined color is contained in the image to be output on the display apparatus 100 based on the result of determination, the controller 600 may simultaneously control the first switch 401 and the second switch 402 (1250) to allow the first light source 311a to emit the first light and the second light source 311b to emit the second light (1350).

Accordingly, the blue light emitted from the first light source 311a may pass through the quantum dot color filter layer 360 and be output as green light and red light having relatively low energy, and the ultraviolet light emitted from the second light source 311b may pass through the quantum dot color filter layer 360 and be output as green light and red light having relatively high energy.

According to the backlight unit 300 according to an embodiment, the display apparatus 100 including the backlight unit 300 and a control method thereof, it is possible to increase the color conversion efficiency of the quantum dots by designing the light source 311 contained in the backlight unit 300, and it is possible to improve the color reproducibility of the display apparatus 100 by representing the deep color that has not been expressed in the related art method. Further, it is possible to implement more realistic image quality by implementing the color having improved high dynamic range (HDR).

Meanwhile, it is understood that one or more embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions that can be decoded or executed by a computer are stored. For example, there may be a Read Only Memory (ROM), a Random Access Memory (RAM), a magnetic tape, a magnetic disk, a flash memory, and an optical data storage device.

Although a few embodiments have been shown and described above, it would be appreciated by those skilled in the art that changes may be made in these embodiments without departing from the principles and spirit of the disclosure, the scope of which is defined at least in the claims and their equivalents.

What is claimed is:

1. A display apparatus comprising:
a first light source configured to emit first light having a first wavelength;
a second light source configured to emit second light having a second wavelength shorter than the first wavelength of the first light;
an image signal receiver configured to receive an image signal from an external device;
a switching portion configured to operate at least one of the first light source or the second light source; and
a controller configured, based on a brightness value of the received image signal, to control the switching portion to selectively allow at least one of the first light source to emit the first light or the second light source to emit the second light.

2. The display apparatus of claim 1, wherein the switching portion comprises:
a first switch configured to operate the first light source to emit the first light according to a control of the controller; and
a second switch configured to operate the second light source to emit the second light according to a control of the controller.

3. The display apparatus of claim 1, wherein the first light emitted from the first light source comprises blue light (BL), and the second light emitted from the second light source comprises ultraviolet light (UV) of a predetermined wavelength.

4. The display apparatus of claim 1, wherein, based on the brightness value of the received image signal being less than a predetermined value, the controller is configured to control the first switch to operate the first light source to emit the first light.

5. The display apparatus of claim 1, wherein, based on the brightness value of the received image signal being equal to or greater than a predetermined value, the controller is configured to control the second switch to operate the second light source to emit the second light.

6. The display apparatus of claim 1, wherein, based on the received image signal corresponding to a signal having a predetermined color, the controller is configured to control the first switch to operate the first light source to emit the first light, and the second switch to operate the second light source to emit the second light.

7. The display apparatus of claim 1, further comprising:
a support configured to fix the first light source and the second light source,
wherein the first light source and the second light source are spaced apart from each other on the support by a predetermined distance.

8. The display apparatus of claim 1, further comprising:
a reflective sheet configured to reflect light,
wherein the reflective sheet comprises through holes formed at positions corresponding to the first light source and the second light source, and
wherein the first light source and the second light source pass through the through holes and protrude from the through holes toward the front of the reflective sheet.

9. The display apparatus of claim 1, further comprising:
a quantum dot color filter layer configured to convert a color of light emitted from at least one of the first light source or the second light source.

10. The display apparatus of claim 9, wherein the quantum dot color filter layer comprises:
a red light converter configured to convert incident light, which is emitted from at least one of the first light source or the second light source and then incident thereon, into red light;
a green light converter configured to convert incident light, which is emitted from at least one of the first light source or the second light source and then incident thereon, into green light; and
a light transmitter configured to transmit incident light, which is emitted from at least one of the first light source or the second light source, and then incident thereon, without converting a color thereof.

11. A backlight unit comprising:
a first light source configured to emit first light having a first wavelength;
a second light source configured to emit second light having a second wavelength shorter than the first wavelength of the first light;
a support configured to fix the first light source and the second light source; and
a reflective sheet configured to reflect at least one of the first light or the second light,
wherein the reflective sheet comprises through holes formed at positions corresponding to the first light source and the second light source, and
wherein the first light source and the second light source pass through the through holes and protrude from the through holes toward the front of the reflective sheet.

12. The backlight unit of claim 11, wherein the first light emitted from the first light source comprises blue light (BL), and the second light emitted from the second light source comprises ultraviolet light (UV) of a predetermined wavelength.

13. The backlight unit of claim 11, further comprising:
a quantum dot color filter layer configured to convert a color of light emitted from at least one of the first light source or the second light source.

14. The backlight unit of claim 11, wherein the quantum dot color filter layer comprises:
a red light converter configured to convert incident light, which is emitted from at least one of the first light source or the second light source and then incident thereon, into red light;
a green light converter configured to convert incident light, which is emitted from at least one of the first light source or the second light source and then incident thereon, into green light; and
a light transmitter configured to transmit incident light, which is emitted from at least one of the first light source or the second light source and then incident thereon, without converting a color thereof.

15. The backlight unit of claim 11, wherein the first light source and the second light source are spaced apart from each other on the support by a predetermined distance.

16. A control method for a display apparatus comprising a first light source configured to emit first light having a first wavelength, a second light source configured to emit second light having a second wavelength shorter than the first wavelength, and a switching portion configured to operate at least one of the first light source or the second light source, the control method comprising:
receiving an image signal input from an external device;
comparing a brightness value of the received image signal with a predetermined value; and
controlling the switching portion to selectively allow, based on a result of the comparing, at least one of the first light source to emit the first light or the second light source to emit the second light.

17. The control method of claim 16, wherein the controlling the switching portion comprises controlling the first switch to operate the first light source to emit the first light based on the brightness value of the received image signal being less than a predetermined value.

18. The control method of claim 17, wherein the controlling the switching portion comprises controlling the second switch to operate the second light source to emit the second light based on the brightness value of the received image signal being equal to or greater than the predetermined value.

19. The control method of claim 18, wherein the controlling the switching portion comprises controlling the first switch to operate the first light source to emit the first light and the second switch to operate the second light source to emit the second light, based on the received image signal corresponding to a signal having a predetermined color.

20. A non-transitory computer-readable recording medium having recorded thereon one or more instructions executable by a processor to perform the control method of claim 16.
